(19) United States
(12) Patent Application Publication
(10) Pub. No.: US 2022/0114458 A1
(43) Pub. Date: Apr. 14, 2022

(54) MULTIMODAL AUTOMATIC MAPPING OF SENSING DEFECTS TO TASK-SPECIFIC ERROR MEASUREMENT

(71) Applicant: Intel Corporation, Santa Clara, CA (US)

(72) Inventors: Maria Soledad ELLI, Hillsboro, OR (US); Javier FELIP LEON, Hillsboro, OR (US); David Israel GONZALEZ AGUIRRE, Portland, OR (US); Javier S. TUREK, Beaverton, OR (US); Ignacio J. ALVAREZ, Portland, OR (US)

(21) Appl. No.: 17/558,603

(22) Filed: Dec. 22, 2021

(51) Int. Cl. G06N 5/02; G06N 20/00; G06K 9/62; B60W 50/02; B60W 60/00

(52) U.S. Cl. CPC G06N 5/022; G06N 20/00; B60W 60/001; G06K 9/6298; B60W 50/02; G06K 9/6262

(57) ABSTRACT

A device may include a processor. The processor may receive sensor data representative of an environment of a vehicle. The processor may also generate task data using the sensor data in accordance with a perception task. In addition, the task data may include a plurality of features of the environment. The processor may identify a latent representation of a negative effect of the environment within the sensor data. Further, the processor may estimate an error distribution for the task data based on the identified latent representation, the task data, and the perception task. The processor may generate output data. The output data may include a normalized distribution of the plurality of features based on the estimated error distribution and the task data.

### FIELD

The aspects discussed in the present disclosure are related to multimodal automatic mapping of sensing defects to task-specific error measurement.

### BACKGROUND

Unless otherwise indicated in the present disclosure, the materials described in the present disclosure are not prior art to the claims in the present application and are not admitted to be prior art by inclusion in this section.

Autonomous Driving (AD) utilizes reliable driving safety systems that process detected data of the environment of an autonomous vehicle (AV) to implement a driving policy of the AV. To do this, various driving models such as various safety driving models may be implemented.

The subject matter claimed in the present disclosure is not limited to aspects that solve any disadvantages or that operate only in environments such as those described above. Rather, this background is only provided to illustrate one example technology area where some aspects described in the present disclosure may be practiced.

### BRIEF DESCRIPTION OF THE DRAWINGS

Example aspects will be described and explained with additional specificity and detail through the use of the accompanying drawings in which:

FIG. 1 illustrates an exemplary AV in accordance with various aspects of the present disclosure;

FIG. 2 illustrates various exemplary electronic components of a safety system of the AV in accordance with various aspects of the present disclosure;

FIG. 3 illustrates a block diagram of an exemplary operational environment to determine error distributions of sensor data from a sensor for perception tasks;

FIG. 4 illustrates a block diagram of an exemplary operational environment to determine the error distribution of sensor data for perception tasks;

FIG. 5 illustrates an exemplary domain specific dataset (DSD) that includes a distribution of negative effects;

FIG. 6 illustrates a block diagram of an exemplary operational environment to train a negative effect latent representation (NELR) module; and

FIG. 7 illustrates a block diagram of an exemplary operational environment to train an estimated error (EE) module; and

FIG. 8 illustrates a flowchart of an exemplary method to generate output data that includes a normalized distribution of features,

all according to at least one aspect described in the present disclosure.

### DETAILED DESCRIPTION

AD may utilize a reliable driving safety system that processes sensor data representative of an environment proximate an AV to implement a driving policy of the AV. To do this, various driving models such as various safety driving models may be implemented. The sensor data may include video data, radio detection and ranging (radar) data, light detection and ranging (LIDAR) data, or any other appropriate type of data.

The AV may include one or more sensors. Negative effects (e.g., conditions) of the environment may impact the sensors differently based on sensor type. The negative effects may introduce errors in the sensor data. For example, a rain condition may introduce more errors in the video data than in the radar data. The negative effects may include a lighting condition, a weather condition (e.g., a cloudy condition, an overcast condition, a gloomy condition, a foggy condition, a windy condition, a stormy condition, a breezy condition, etc.), a sensor malfunction, a sensor calibration issue, or any other appropriate environmental condition.

The AV may perform one or more perception tasks using the sensor data. The perception tasks may identify or determine information that is relevant to autonomously controlling the AV. The negative effects may introduce errors such that an error distribution for each of the perception tasks may be different based on a corresponding task type. For example, an object location perception task may include locating an object and an object identifying perception task may include identifying an object class of the object and the rain condition may include a greater error distribution in the object locating perception task than in the identifying perception task.

The error distributions due to the different negative effects may have different impacts on operation of the AV depending on which safety features are impacted. For example, the error distribution due to the rain condition for the object detection perception task may impact the operation of the AV more than the error distribution due to the rain condition for the object classification perception task because avoiding the object may be associated with a higher safety setting of the AV.

The AV may implement a machine learning (ML) algorithm or artificial intelligence (AI) algorithm configured to extract relevant information from the sensor data for autonomous control of the AVT. The AV may use analytical methods for estimating the error distribution in the sensor data analyzed by the ML algorithm or the AI algorithm. Some technologies may restrict an output of the analytical methods to parametric distributions that include closed solutions in probability density function, which may result in only approximations of the errors.

Some AV technologies may perform adaptive filtering to remove errors from the sensor data (e.g., try to reduce the error distribution to zero). These AV technologies may not account for or correct the errors in the sensor data. These and other AV technologies may filter out errors and multiple filtered signals may be merged using components that may introduce new errors (e.g., a noisy Or gate).

Some AV technologies may include a Bayesian neural network (BNN) implemented as a deep ML algorithm. The BNN may account for the different error distributions by adjusting weights within the BNN. These AV technologies may go through multiple forward passes to determine the error distribution in the sensor data for a corresponding perception task. These AV technologies may introduce latencies into the operation of the perception task.

Some AV technologies may determine the error distribution using an end-to-end uncertainty calibration and confidence estimation. These AV technologies may increase computation power, introduce latencies, or some combination thereof for the perception task.

Some aspects described in the present disclosure may include a perception task module that determines the error distribution of the sensor data using latent representations of the errors, which may permit the AV to correct the errors or reduce computation power for the perception task. The perception task module may include a multimodal task-specific approach for learning and mapping the negative effects. The perception task module may also map the negative effects from a sensor space to the error distribution in output data. The perception task module may learn to identify the latent representations of the negative effects using a DSD.

A device may include a processor that includes the perception task module. The perception task module may receive sensor data representative of an environment of the vehicle. The perception task module may also generate task data using the sensor data. The task data may be generated in accordance with the perception task. The task data may include features of the environment. In addition, the perception task module may identify a latent representation of a negative effect of the environment within the sensor data. Further, the perception task module may estimate the error distribution for the task data based on the identified latent representation, the task data, the perception task, or some combination thereof. The perception task module may generate the output data. The output data may include a normalized distribution of the errors in the sensor data based on the estimated error distribution and the task data.

One or more aspects described in the present disclosure may more accurately determine the error distribution than other technologies because the negative effects are mapped for specific perception tasks and are based on the sensor type. The error distribution may be determined for specific perception tasks rather than the entire AV or all of the sensors combined. In addition, one or more aspects described in the present disclosure may reduce processing latency, power consumption, or some combination thereof compared to other technologies. For example, the error distribution according to the one or more aspects described in the present disclosure may be determined using two forward passes compared to the twenty-forty forward passes the other technologies may implement. The output data generated according to the one or more aspects described in the present disclosure may include a clearer correlation between the negative effects and operation of the AV.

These and other aspects of the present disclosure will be explained with reference to the accompanying figures. It is to be understood that the figures are diagrammatic and schematic representations of such example aspects, and are not limiting, nor are they necessarily drawn to scale. In the figures, features with like numbers indicate like structure and function unless described otherwise.

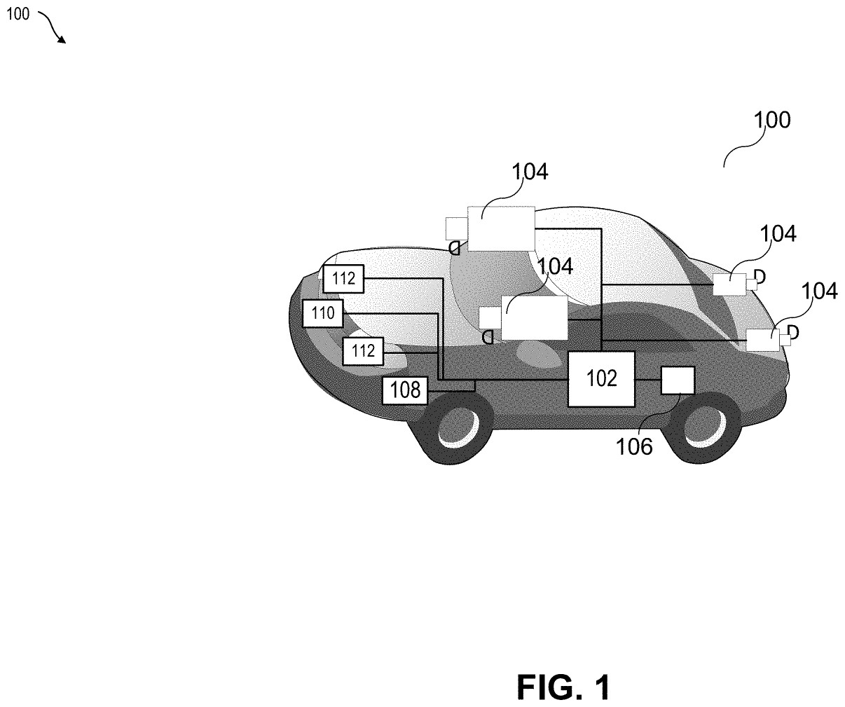

FIG. 1 illustrates an exemplary AV, namely vehicle 100, in accordance with various aspects of the present disclosure. Vehicle 100 may include one or more processors 102, one or more image acquisition devices 104, one or more position sensors 106, one or more speed sensors 108, one or more radar sensors 110, and/or one or more LIDAR sensors 112. Vehicle 100 may include an AV.

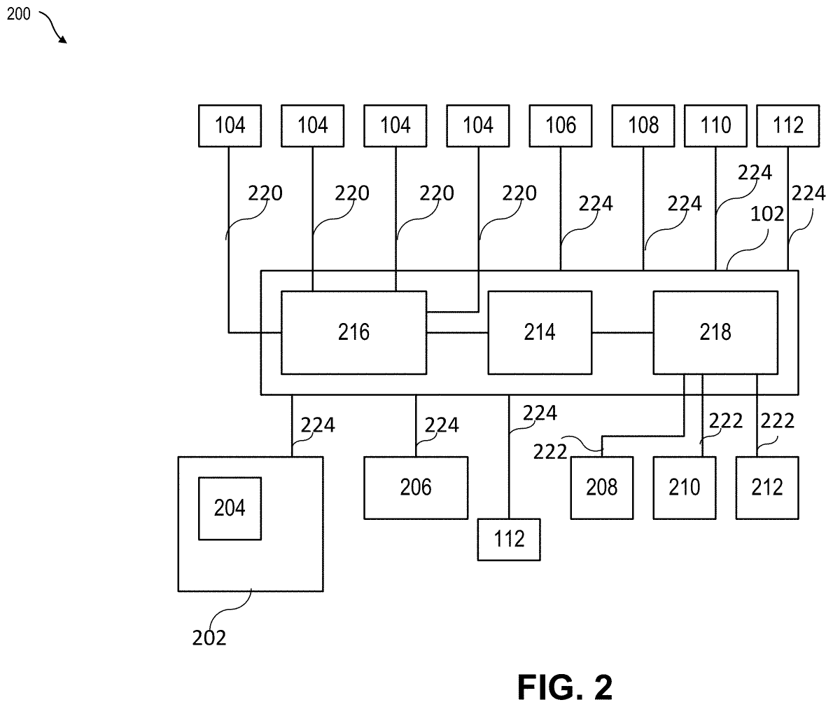

Vehicle 100 may include a safety system 200 (as described with respect to FIG. 2 below). It is appreciated that vehicle 100 and safety system 200 are exemplary in nature and may thus be simplified for explanatory purposes. Locations of elements and relational distances (as discussed above, the figures are not to scale) are provided as examples and are not limited thereto. The safety system 200 may include various components depending on the requirements of a particular implementation.

FIG. 2 illustrates various exemplary electronic components of the safety system 200, in accordance with various aspects of the present disclosure. The safety system 200 may include one or more processors 102, one or more image acquisition devices 104 (e.g., one or more cameras), one or more position sensors 106 (e.g., a Global Navigation Satellite System (GNSS), a Global Positioning System (GPS), among others) one or more speed sensors 108, one or more radar sensors 110, and/or one or more LIDAR sensors 112. Safety system 200 may further include one or more memories 202, one or more map databases 204, one or more user interfaces 206 (e.g., a display, a touch screen, a microphone, a loudspeaker, one or more buttons and/or switches, etc.), and/or one or more wireless transceivers 208, 210, 212. The wireless transceivers 208, 210, 212 may be configured according to the same, different, or any combination thereof radio communication protocols or standards. By way of example, a wireless transceiver (e.g., a first wireless transceiver 208) may be configured in accordance with a Short-Range mobile radio communication standard (e.g., Bluetooth, Zigbee, among others). As another example, a wireless transceiver (e.g., a second wireless transceiver 210) may be configured in accordance with a Medium or Wide Range mobile radio communication standard (e.g., 3G (e.g. Universal Mobile Telecommunications System—UMTS), 4G (e.g. Long Term Evolution—LTE), and/or 5G mobile radio communication standard in accordance with corresponding 3GPP (3rd Generation Partnership Project) standards, among others). As a further example, a wireless transceiver (e.g., a third wireless transceiver 212) may be configured in accordance with a Wireless Local Area Network communication protocol or standard (e.g., IEEE 802.11, 802.11, 802.11a, 802.11b, 802.11g, 802.11n, 802.11p, 802.11-12, 802.11ac, 802.11ad, 802.11ah, among others). The one or more wireless transceivers 208, 210, 212 may be configured to transmit signals via an antenna system over an air interface.

The one or more processors 102 may include an application processor 214, an image processor 216, a communication processor 218, and/or any other suitable processing device. Image acquisition device(s) 104 may include any number of image acquisition devices and components depending on the requirements of a particular application. Image acquisition devices 104 may include one or more image capture devices (e.g., cameras, CCDs (charge coupling devices), or any other type of image sensor).

The safety system 200 may also include a data interface communicatively connecting the one or more processors 102 to the one or more image acquisition devices 104. For example, a first data interface may include any wired and/or wireless first link 220 or first links 220 configured to transmit image data acquired by the one or more image acquisition devices 104 to the one or more processors 102 (e.g., to the image processor 216).

The wireless transceivers 208, 210, 212 may, in some aspects, be coupled to the one or more processors 102 (e.g., to the communication processor 218) via, for example a second data interface. The second data interface may include any wired and/or wireless second link 222 or second links 222 configured to transmit radio transmitted data acquired by wireless transceivers 208, 210, 212 to the one or more processors 102, e.g., to the communication processor 218.

The memories 202 as well as the one or more user interfaces 206 may be coupled to each of the one or more processors 102, e.g., via a third data interface. The third data interface may include any wired and/or wireless third link 224 or third links 224. Furthermore, the position sensor 106 may be coupled to each of the one or more processors 102, e.g., via the third data interface.

Such transmissions may also include communications (e.g., one-way or two-way) between the vehicle 100 and one or more other (target) vehicles in an environment of the vehicle 100 (e.g., to facilitate coordination of navigation of the vehicle 100 in view of or together with other (target) vehicles in the environment of the vehicle 100), or even a broadcast transmission to unspecified recipients in a vicinity of the transmitting vehicle 100.

One or more of the transceivers 208, 210, 212 may be configured to implement one or more vehicle to everything (V2X) communication protocols, which may include vehicle to vehicle (V2V), vehicle to infrastructure (V2I), vehicle to network (V2N), vehicle to pedestrian (V2P), vehicle to device (V2D), vehicle to grid (V2G), and other protocols.

Each processor 214, 216, 218 of the one or more processors 102 may include various types of hardware-based processing devices. By way of example, each processor 214, 216, 218 may include a microprocessor, pre-processors (such as an image pre-processor), graphics processors, a central processing unit (CPU), support circuits, digital signal processors, integrated circuits, memory, or any other types of devices suitable for running applications and for image processing and analysis. Each processor 214, 216, 218 may include any type of single or multi-core processor, mobile device microcontroller, central processing unit, etc. These processor types may each include multiple processing units with local memory and instruction sets. Such processors may include video inputs for receiving image data from multiple image sensors and may also include video out capabilities.

Any of the processors 214, 216, 218 disclosed herein may be configured to perform certain functions in accordance with program instructions which may be stored in a memory of the one or more memories 202. A memory of the one or more memories 202 may store software that, when executed by a processor (e.g., by the one or more processors 102), controls the operation of the system, e.g., the safety system. A memory of the one or more memories 202 may store one or more databases and image processing software, as well as a trained system, such as a neural network, or a deep neural network, for example. The one or more memories 202 may include any number of random-access memories, read only memories, flash memories, disk drives, optical storage, tape storage, removable storage and other types of storage.

The safety system 200 may further include components such as a speed sensor 108 (e.g., a speedometer) for measuring a speed of the vehicle 100. The safety system may also include one or more accelerometers (either single axis or multiaxis) (not shown) for measuring accelerations of the vehicle 100 along one or more axis. The safety system 200 may further include additional sensors or different sensor types such as an ultrasonic sensor, a thermal sensor, one or more radar sensors 110, one or more LIDAR sensors 112 (which may be integrated in the head lamps of the vehicle 100), and the like. The radar sensors 110 and/or the LIDAR sensors 112 may be configured to provide pre-processed sensor data, such as radar target lists or LIDAR target lists. The third data interface may couple the speed sensor 108, the one or more radar sensors 110 and the one or more LIDAR sensors 112 to at least one of the one or more processors 102.

The one or more memories 202 may store data, e.g., in a database or in any different format, that, e.g., indicate a location of known landmarks. The one or more processors 102 may process sensory information (such as images, radar signals, depth information from LIDAR or stereo processing of two or more images) of the environment of the vehicle 100 together with position information, such as a GPS coordinate, a vehicle's ego-motion, etc., to determine a current location of the vehicle 100 relative to the known landmarks, and refine the determination of the vehicle's location. Certain aspects of this technology may be included in a localization technology such as a mapping and routing model.

The map database 204 may include any type of database storing (digital) map data for the vehicle 100, e.g., for the safety system 200. The map database 204 may include data relating to the position, in a reference coordinate system, of various items, including roads, water features, geographic features, businesses, points of interest, restaurants, gas stations, etc. The map database 204 may store not only the locations of such items, but also descriptors relating to those items, including, for example, names associated with any of the stored features. A processor of the one or more processors 102 may download information from the map database 204 over a wired or wireless data connection to a communication network (e.g., over a cellular network and/or the Internet, etc.). The map database 204 may store a sparse data model including polynomial representations of certain road features (e.g., lane markings) or target trajectories for the vehicle 100. The map database 204 may also include stored representations of various recognized landmarks that may be provided to determine or update a known position of the vehicle 100 with respect to a target trajectory. The landmark representations may include data fields such as landmark type, landmark location, among other potential identifiers.

Furthermore, the safety system 200 may include a driving model, e.g., implemented in an advanced driving assistance system (ADAS) and/or a driving assistance and automated driving system. By way of example, the safety system 200 may include (e.g., as part of the driving model) a computer implementation of a formal model such as a safety driving model. A safety driving model may be or include a mathematical model formalizing an interpretation of applicable laws, standards, policies, etc. that are applicable to self-driving (ground) vehicles. A safety driving model may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic and in turn limit the scalability of system deployment; and third, the interpretation should be efficiently verifiable in the sense that it can be rigorously proven that the self-driving (autonomous) vehicle correctly implements the interpretation of the law. A safety driving model, illustratively, may be or include a mathematical model for safety assurance that enables identification and performance of proper responses to dangerous situations such that self-perpetrated accidents can be avoided.

A safety driving model may implement logic to apply driving behavior rules such as the following five rules: Do not hit someone from behind; Do not cut-in recklessly; Right-of-way is given, not taken; Be careful of areas with limited visibility; and If you can avoid an accident without causing another one, you must do it.

It is to be noted that these rules are not limiting and not exclusive and can be amended in various aspects as desired. The rules rather represent a social driving contract that might be different depending on the region and may also develop over time. While these five rules are currently applicable in most of the countries they might not be complete and may be amended.

As described above, the vehicle 100 may include the safety system 200 as also described with reference to FIG. 2.

The vehicle 100 may include the one or more processors 102 e.g. integrated with or separate from an engine control unit (ECU) of the vehicle 100.

The safety system 200 may in general generate data to control or assist to control the ECU and/or other components of the vehicle 100 to directly or indirectly control the driving of the vehicle 100.

Although the following aspects will be described in association with the safety driving model, any other driving model may be provided in alternative implementations.

The one or more processors 102 of the vehicle 100 may implement the following aspects and methods.

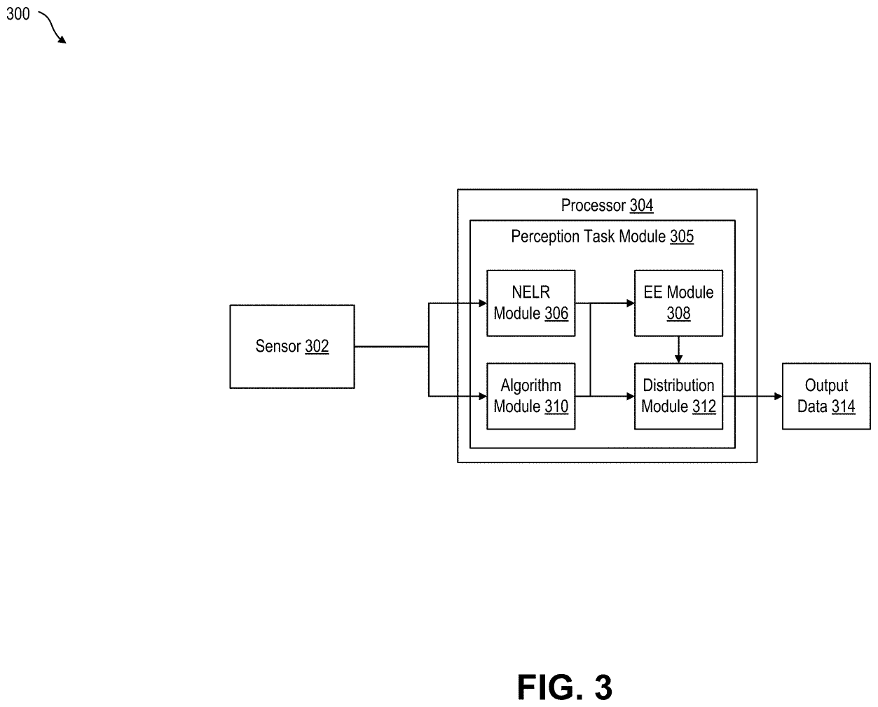

FIG. 3 illustrates a block diagram of an exemplary operational environment 300 to determine error distributions of sensor data from a sensor 320 for perception tasks, in accordance with at least one aspect described in the present disclosure. The operational environment 300 may include the sensor 302 and a processor 304.

The sensor 302 may include a camera sensor, a radar sensor, a lidar sensor, a sonar sensor, a microphone sensor, or some combination thereof. The sensor 302 may correspond to the one or more image acquisition devices 104, the one or more position sensors 106, the one or more speed sensors 108, the one or more radar sensors 110, the one or more LIDAR sensors 112, or some combination thereof of FIGS. 1 and 2.

The processor 304 may include a perception task module 305. The processor 304 may correspond to the one or more of the processors 102 of FIGS. 1 and 2. The perception task module 305 may include a NELR module 306, an EE module 308, an algorithm module 310, a distribution module 312, or some combination thereof.

The NELR module 306, the EE module 308, the algorithm module 310, the distribution module 312, or some combination thereof may include code and routines configured to enable the processor 304 to perform one or more operations with respect to determining the error distributions of the sensor data. Additionally or alternatively, the NELR module 306, the EE module 308, the algorithm module 310, the distribution module 312, or some combination thereof may be implemented using hardware including a processor, a microprocessor (e.g., to perform or control performance of one or more operations), a field programmable gate array (FPGA), an application-specific integrated circuit (ASIC), a network interface card (NIC), a CPU, a graphics processing unit (GPU), a physical accelerator, or any other appropriate accelerator. The NELR module 306, the EE module 308, the algorithm module 310, the distribution module 312, or some combination thereof may be implemented using a combination of hardware and software.

The perception task module 305 may receive sensor data from the sensor 302. The perception task module 305 may also generate output data 314 representative of the error distribution of the sensor data. The NELR module 306 may identify latent representations of negative effects in the sensor data. The NELR module 306 may include multiple NELR modules. Each of the NELR modules of the NELR module 306 may be configured to identify latent representations in the sensor data for different perception tasks. In addition, the EE module 308 may estimate the error distribution of the sensor data. The EE module 308 may include multiple EE modules. Each of the EE modules of the EE module 308 may be configured to estimate the error distribution of the sensor data for different perception tasks.

The sensor 302 may capture sensor data representative of the environment proximate a vehicle (e.g., the vehicle 100 of FIG. 1). For example, the sensor 302 may capture first sensor data of a first data type and second sensor data of a second data type representative of different aspects of the environment.

The NELR module 306 may receive the first sensor data from the sensor 302. The NELR module 306 (e.g., a first NELR module of the NELR module 306) may also identify a first latent representation of a negative effect of the environment within the first sensor data. In addition, the NELR module 306 may receive the second sensor data from the sensor 302. Further, the NELR module 306 (e.g., a second NELR module of the NELR module 306) may identify a second latent representation of a negative effect of the environment within the second sensor data.

The latent representation may represent different adverse conditions of the environment of the vehicle. The NELR module 306 may map the negative effects according to Equation 1.

f: [symbol] ^{M}→ [symbol] ^{P} Equation 1

In Equation 1, M may represent a dimensionality of the sensor data and P may represent a dimensionality of a vector indicating an intensity of pre-identified latent representations. The dimensionality of the sensor data, for example, may include a single red green blue (RGB) image, a combination of lidar data, camera data, and radar data.

The algorithm module 310 may include multiple algorithm modules. Each of the algorithm modules of the algorithm module 310 may be configured to perform a different perception task. The algorithm module 310 may receive the first sensor data and the second sensor data. The algorithm module 310 (e.g., a first algorithm module of the algorithm module 310) may also generate first task data using the first sensor data. The first task data may include a first set of features of the environment corresponding to the first perception task. In addition, the algorithm module 310 (e.g., a second algorithm module of the algorithm module 310) may generate second task data using the second sensor data. The second task data may include a second set of features of the environment.

The EE module 308 (e.g., a first EE module of the EE module 308) may estimate a first error distribution for the first task data. The EE module 308 may estimate the first error distribution based on the first identified latent representation, the first task data, the first perception task, or some combination thereof. The EE module 308 (e.g., a second EE module of the EE module 308) may estimate a second error distribution for the second task data. The EE module 308 may estimate the second error distribution based on the second identified latent representation, the second task data, the second perception task, or some combination thereof.

The distribution module 312 may generate the output data 314. The output data 314 may include first output data and second output data. The first output data may include a normalized distribution of the first set of features based on the first estimated error distribution, the first task data, or some combination thereof. For example, the distribution module 312 may map the first latent representation to the first set of features. The second output data may include a normalized distribution of second set of features based on the second estimated error distribution, the second task data, or some combination thereof. For example, the distribution module 312 may map the second latent representation to the second set of features.

The perception task module 305 may provide the output data 314 to a risk analysis component (e.g., a responsibility sensitive safety model) (not illustrated in FIG. 3) to perform a risk analysis of operational parameters of the vehicle using the output data 314.

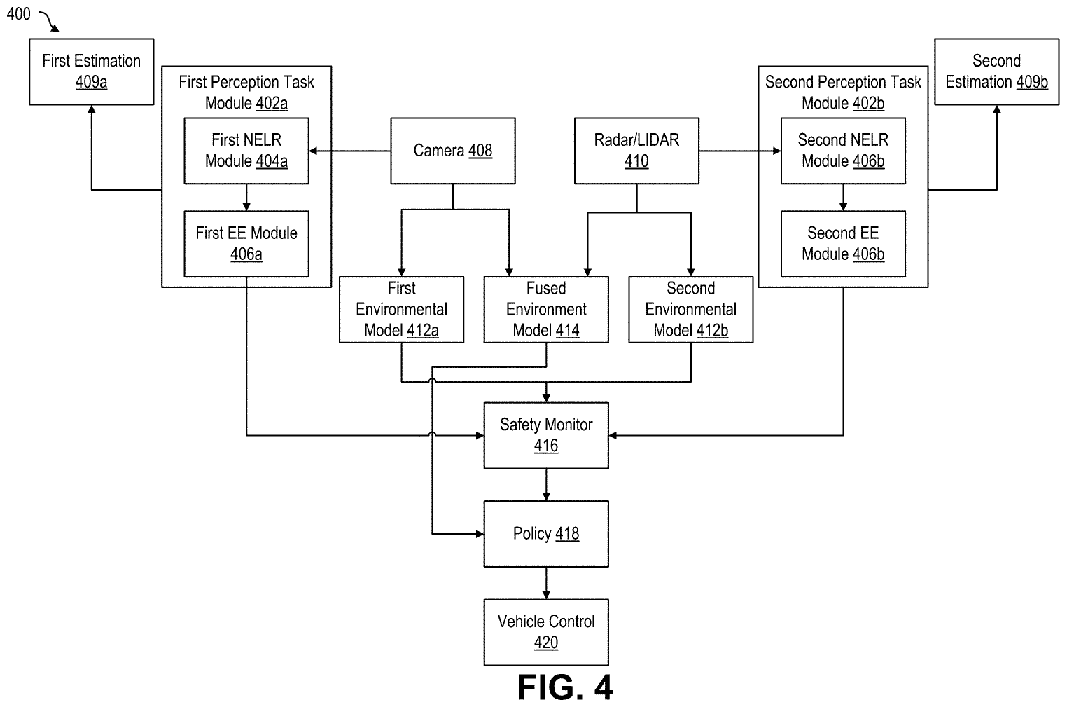

FIG. 4 illustrates a block diagram of an exemplary operational environment 400 to determine the error distribution of sensor data for perception tasks, in accordance with at least one aspect described in the present disclosure. The operational environment 400 may include a first perception task module 402a and a second perception task module 402b. The first perception task module 402a and the second perception task module 402b may correspond to the perception task module 305 of FIG. 3.

A first environmental model 412a may be generated based on first sensor data from a camera 408. For example, a first algorithm module (not illustrated in FIG. 4) may generate the first environment model 412a based on the first sensor data according to a first perception task. The first environment model 412a may correspond to the first task data and may include a first set of features of the environment of the vehicle.

The first perception task module 402a may receive the first sensor data from the camera 408. A first NELR module 404a of the first perception task module 402a may identify a first latent representation of a negative effect within the first sensor data. A first EE module 406a of the first perception task module 402a may generate a first estimation 409a. The first estimation 409a may include a first error distribution for the first task data. The first EE module 406a may estimate the first error distribution for the first perception task and the first sensor data.

A second environmental model 412b may be generated based on second sensor data from a Radar/LIDAR 410. For example, a second algorithm module (not illustrated in FIG. 4) may generate the second environment model 412b based on the second sensor data according to a second perception task. The second environment model 412b may correspond to the second task data and may include a second set of features of the environment of the vehicle. In addition, a fused environment model 414 may be generated based on the first sensor data and the second sensor data. The fused environment model 414 may include a global environment representation (e.g., a fused representation of the first environmental model 412a and the second environmental module 412b).

The second perception task module 402b may receive the second sensor data from the Radar/LIDAR 410. A second NELR module 404b of the second perception task module 402b may identify a second latent representation of a negative effect within the second sensor data. A second EE module 406b of the second perception task module 402b may generate a second estimation 409b. The second estimation 409b may include a second error distribution for the second task data. The second EE module 406b may estimate the second error distribution for the second perception task and the second sensor data.

A safety monitor 416 may receive the first environmental model 412a, the second environmental model 412b, the fused environment model 414, the first estimation 409a, the second estimation 409b, or some combination thereof. The safety monitor 416 may identify safety issues for operation of the vehicle within the environment based on the first environmental model 412a, the second environmental model 412b, the fused environment model 414, the first estimation 409a, the second estimation 409b, or some combination thereof.

The safety monitor 416 may provide a message to a policy 418 to identify operational commands for the vehicle. The policy 418 may use the message and the fused environment 414 to identify the operational commands for the vehicle. The policy 418 may provide the operational commands to a vehicle control 420 to control driving of the vehicle accordingly.

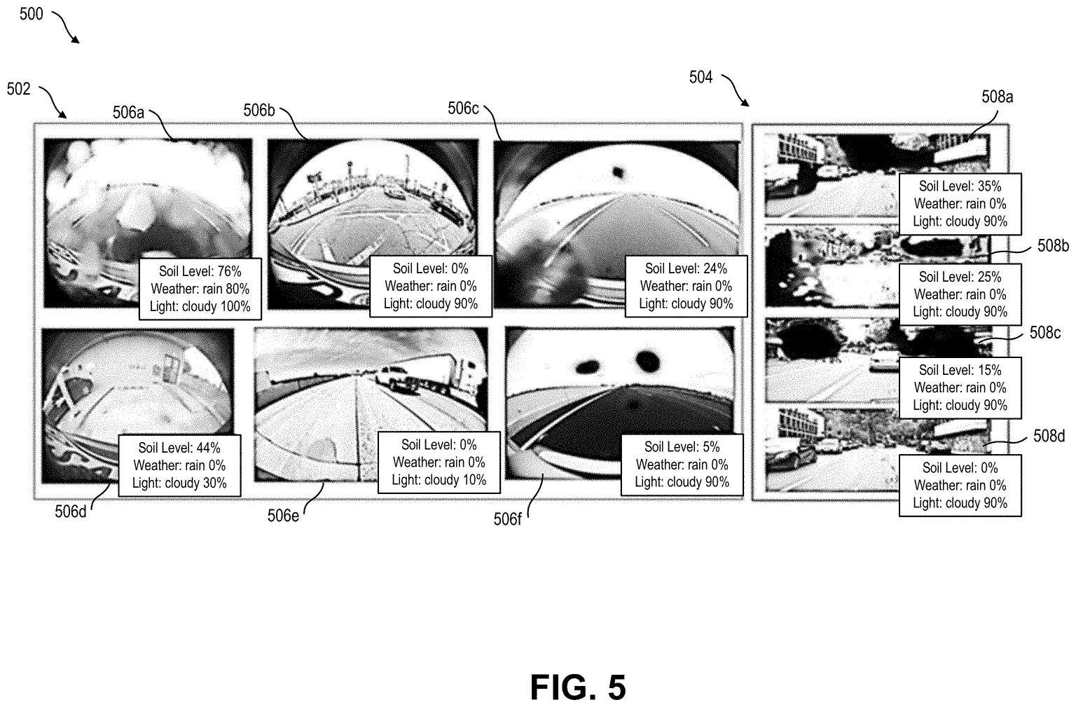

FIG. 5 illustrates an exemplary DSD 500 that includes a distribution of negative effects, in accordance with at least one aspect described in the present disclosure. The DSD 500 corresponds to a particular perception task. For example, the DSD 500 may correspond to the object detection perception task. The DSD 500 may be used to train a NELR module (e.g., the NELR module 306 of FIG. 3), an EE module (e.g., the EE module 308 of FIG. 3), or some combination thereof.

The DSD 500 illustrated in FIG. 5 includes multiple frames that correspond to images captured by camera sensors. The DSD 500 may include a rear-facing camera set of frames 502 and a forward-facing set of frames 504.

The rear-facing camera set of frames 502 may include multiple frames 506a-f that correspond to different negative effects that impact a rear-facing camera. For example, a first frame 506a may include an image that corresponds to a soil level of seventy six percent of the rear-facing camera, a rain condition of eighty percent, and a cloudy condition of one hundred percent. As another example, a fifth frame 506e may include an image that corresponds to a soil level of zero percent of the rear-facing camera, a rain condition of zero percent, and a cloudy condition of ten percent.

The forward-facing set of frames 504 may include multiple frames 508a-d that correspond to different negative effects that impact a forward-facing camera. For example, a second frame 508b may include an image that corresponds to a soil level of thirty five percent of the forward-facing camera, a rain condition of zero percent, and a cloudy condition of ninety percent. As another example, a third frame 508c may include an image that corresponds to a soil level of twenty five percent of the forward-facing camera, a rain condition of zero percent, and a cloudy condition of ninety percent.

The DSD 500 is illustrated in FIG. 5 as including six frames 506a-f for the rear-facing camera set of frames 502 and four frames 508a-d for the forward-facing set of frames 504 for example purposes. The DSD 500 may include any appropriate number of frames for the rear-facing camera set of frames 502, the forward-facing set of frames 504, or some combination thereof.

The DSD 500 is illustrated in FIG. 5 as including image frames for example purposes. The DSD 500 may include any type of appropriate sensor data and corresponding negative effects. For example, the DSD 500 may include video data, radar data, LIDAR data, or any other appropriate type of data and corresponding negative effects.

The DSD 500 may include domain specific (e.g., perception task specific) data that may be used to the train the NELR module, the EE module, or some combination thereof. The DSD 500 may include raw sensor data and additional information that indicates scope, feasibility, and representativity of the DSD 500.

The DSD 500 may be generated using simulations of real-world environments. Alternatively, the DSD 500 may be generated using sensor data representative of real-world environments of vehicles. The DSD 500 may be generated to include a realistic distribution of the negative effects (e.g., defects, environment conditions, or any other appropriate negative effect) that may impact performance of the corresponding perception task.

For example, if the corresponding perception task includes the object classification perception task and uses RGB camera input, the DSD 500 may include negative effects known to impact the object classification perception task. The negative effects may include different weather conditions, soiling in the camera lens, unpropitious lighting conditions, etc.

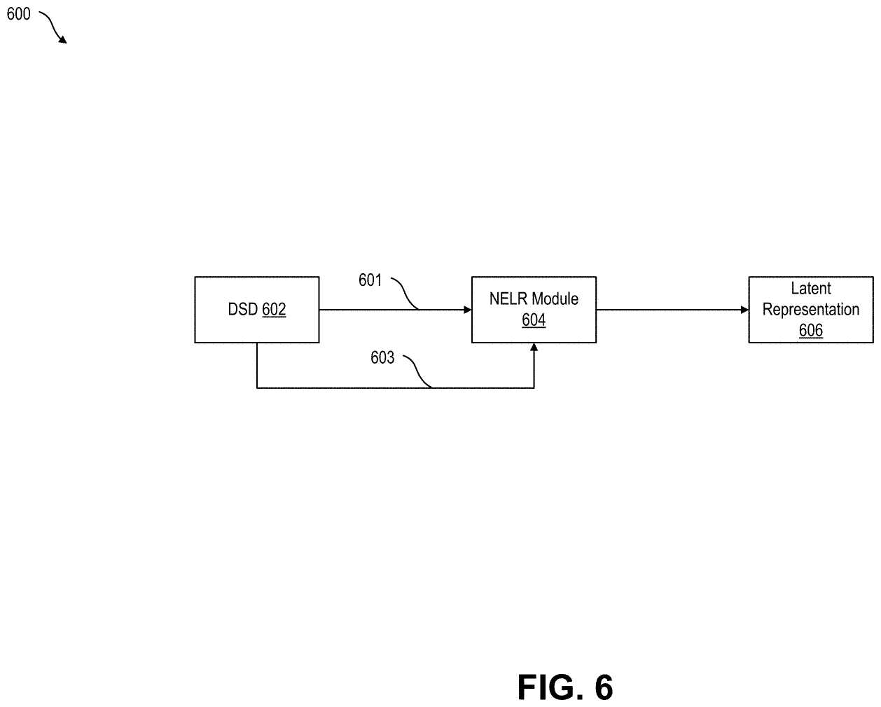

FIG. 6 illustrates a block diagram of an exemplary operational environment 600 to train a NELR module 604, in accordance with at least one aspect described in the present disclosure. The NELR module 604 may correspond to the NELR module 306, the first NELR module 404a, and the second NELR module 404b of FIGS. 3 and 4. The NELR module 604 may be trained to identify latent representations of negative effects within sensor data.

The NELR module 604 may receive a DSD 602. The DSD 602 may correspond to the DSD 500 of FIG. 5. The DSD 602 may include sensor data that includes pre-identified latent representations 601 and ground truth labels 603 corresponding to the pre-identified latent representations.

The NELR module 604 may be trained using a ML algorithm, an AI algorithm, or any other appropriate algorithm. The NELR module 604 may be trained using the ML algorithm, the AI algorithm, the pre-identified latent representations 601, the ground truth labels 603, or some combination thereof. The NELR module 604 may be trained by comparing the pre-identified latent representations 601 to the ground truth labels 603. The NELR module 604 may be trained to identify a latent representation 606 of sensor data.

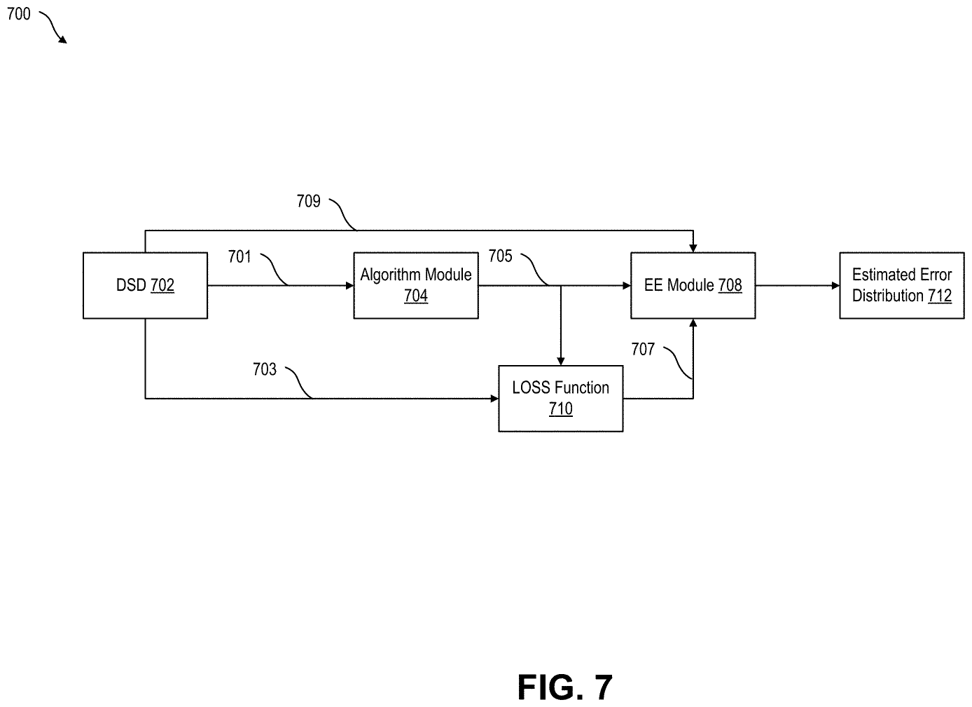

FIG. 7 illustrates a block diagram of an exemplary operational environment 700 to train an EE module 708, in accordance with at least one aspect described in the present disclosure. The EE module 708 may correspond to the EE module 308, the first EE module 406a, and the second EE module 406b of FIGS. 3 and 4. The operational environment 700 may include the EE module 708, a LOSS function 710, and an algorithm module 704. The algorithm module 704 may correspond to the algorithm module 310 of FIG. 3.

The EE module 708 may be trained to estimate an expected error distribution for the algorithm module 704. The EE module 708 may also be trained to be input sensitive (e.g., to estimate the error distribution based on data type of the sensor data).

The algorithm module 704 may receive a DSD 702. The DSD 702 may correspond to the DSD 500 of FIG. 5. The DSD 702 may include sensor data that includes pre-identified latent representations 709, ground truth labels 703 corresponding to the pre-identified latent representations, and training sensor data 701. The algorithm module 704 may receive the training sensor data 701 and may generate training task data 705 using the training sensor data 701. The algorithm module 704 may generate the training task data 705 in accordance with a corresponding perception task.

The LOSS function 710 may receive the ground truth labels 703 and the training task data. The LOSS function 710 may also determine a set of pre-identified errors 707 of the perception task corresponding to the algorithm module 704. The set of pre-identified errors 707 may be generated using a loss function, the training task data 705, the ground truth labels 703, or some combination thereof.

The EE module 708 may be trained using a ML algorithm, an AI algorithm, or any other appropriate algorithm. The EE module 708 may be trained using the ML algorithm, the AI algorithm, the training task data 705, the pre-identified latent representations 709, the set of pre-identified errors 707, or some combination thereof. The EE module 708 may be trained by comparing the training task data 705 with the pre-identified latent representations 709 and the set of pre-identified errors 707. The EE module 708 may be trained to estimate an error distribution 712 of sensor data.

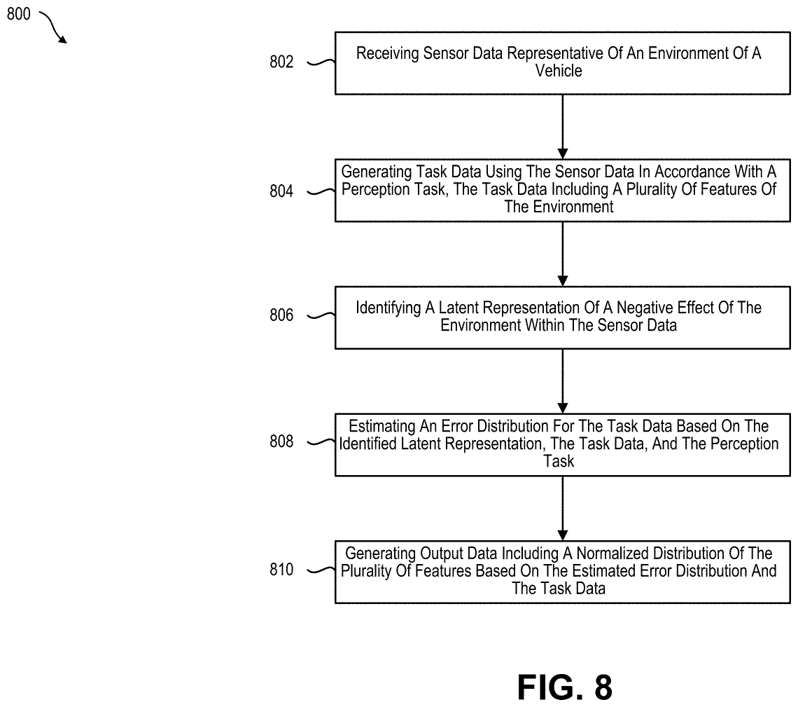

FIG. 8 illustrates a flowchart of an exemplary method 800 to generate output data that includes a normalized distribution of features, in accordance with at least one aspect described in the present disclosure. The method 800 may include receiving sensor data representative of an environment of a vehicle 802; generating task data using the sensor data in accordance with a perception task, the task data including a plurality of features of the environment 804; identifying a latent representation of a negative effect of the environment within the sensor data 806; estimating an error distribution for the task data based on the identified latent representation, the task data, and the perception task 808; and generating output data including a normalized distribution of the plurality of features based on the estimated error distribution and the task data 810.

Modifications, additions, or omissions may be made to the method 800 without departing from the scope of the present disclosure. For example, the operations of method 800 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described aspects.

The perception task module may determine the error distribution of the sensor data using latent representations of errors. The perception task module may include a multimodal task-specific approach for learning and mapping the negative effects. The perception task module may also map the negative effects from the sensor space to the error distribution in the output data. The perception task module may learn to identify the latent representations of the negative effects using the DSD.

The perception task module may provide a method to learn latent representations of error sources, uncertainty sources, or some combination thereof using domain specific knowledge that is relevant to the task. The perception task module may estimate the error distribution for a joint distribution of task data of a specific perception task.

The negative effects in the sensor data may include variable environmental conditions, sensor failures, or some combination thereof. Each negative effect may differently impact the error distribution based on the perception task (e.g., classification, detection, segmentation, etc.).

Each perception task may perform different operations using the same sensor data (e.g., vehicle detection, pedestrian detection, traffic light detection and classification, etc.) to generate environmental models. The environmental models may be fused into a global environment representation. Different environmental conditions may differently impact the fused global environment depending on the perception tasks.

The perception task module may focus on deviations of the output of a perception task. The sensor data may include input from one or more sensors available in the system. The perception task module may use a NELR module, an EE module, or some combination thereof. The NELR module, the EE module, or some combination thereof may be trained using semi-supervised leaning using domain expert knowledge.

The perception task module may account for changes in extrinsic calibration and usage of a sensor. The perception task module may calculate uncertainty estimates for the output of a particular perception task (e.g., object detection, speed calculation, object classification) based on all of the sensor data to perform the perception task.

Different negative effects (e.g., environmental conditions) such as weather, traffic, or unfavorable sensor conditions may differently impact perceptions of the environment of the AV. Modelling an extent to which these different negative effects cause different performance degradations of different perception tasks may improve safety of the AV. The perception task module may learn the latent representation of the negative effects that directly impact the performance of the different perception tasks.

If the perception tasks include object speed detection and traffic light detection, the sensor data may be received from two frontal cameras in addition to a radar sensor. If the environment conditions include heavy rain, fog, or direct sunlight (overexposed frames), the different perception tasks may be impacted differently by the environment conditions. For example, the perception module may be able to calculate the speed of the object because radars are not impacted rain, fog, or sunlight. However, the traffic light detection perception task may be impacted by these environmental conditions. Therefore, identifying per-perception task error distributions due to negative effects present in the sensor data (e.g., due to different environmental factors) may permit the perception task module to generate a more correct fused environmental model or make decisions based on a more correct fused environmental model.

The perception task module may train the NELR module, the EE module, or some combination thereof using the DSD. The DSD may include a realistic distribution of defects and environmental conditions that affect the performance of a given perception task.

The NELR module may map the negative effects in the sensor data to a negative effect latent representation using features present in the DSD and that contribute the most to the performance degradation of the given task.

The NELR module may include a ML algorithm or an AI algorithm. The ML algorithm or the AI algorithm may be selected based on the type of sensor data and the ground truth labels in the DSD. For example, if the sensor data includes RGB data, the ML algorithm of the NELR module may include a convolutional neural network (CNN). The CNN may be trained to include a general loss function for regression (e.g., a mean squared error), an optimizer (e.g. a stochastic gradient descent or ADAM)), or some combination thereof.

The EE module may predict an error distribution of an output data for a specific perception task based on the identified latent representations in the sensor data. The EE module may be trained to estimate an error distribution for the perception task. The EE module may be trained using sensor data, task data, global truth labels. The EE module may correlate dependencies between the identified latent representations and error of the perception task. The EE module may permit the perception task module to determine an impact that environmental conditions and sensor failures may cause.

The NELR module and the EE module may form part of a perception pipeline of the AV. The NELR module and the module may form independent and per perception task operations. The NELR module and the EE module may determine the error distribution (e.g., the impact) of adverse weather conditions on the sensor data for the perception task for consideration in path planning and decision making. For example, a different NELR module and a different EE module may be implemented for each perception task of the perception pipeline in order to infer the error distribution of the different functionalities (e.g. one for pedestrian detection, another for vehicle position and speed calculation, yet another for intention prediction, a further for traffic light recognition, a further yet for traffic sign recognition, etc.). Alternatively, a NELR module and an EE module may be implemented only for specific perception tasks that are impacted by sensor failure, weather conditions or to the ones that have the highest impact on safety of the AV (e.g., sensitive perception tasks).

The EE module may not process raw data, which may permit the size of the EE module to be small. The EE module may operate in parallel with other operations to reduce latency of the AV pipeline. The NELR module may perform independent operations and may operate in parallel to the task algorithm to reduce latency of the AV pipeline.

A device may include a processor that includes the perception task module. The device may include an AV navigation system. The perception task module may receive the DSD. The DSD may include pre-identified latent representations, ground truth labels corresponding to the pre-identified latent representations, training sensor data or some combination thereof. The DSD may include a domain specific distribution of sensor defects and environmental conditions. The perception task module may train a NELR module using a ML algorithm, the pre-identified latent representations, the ground truth labels, or some combination thereof. The NELR module may be trained to identify the latent representation of the negative effect within the sensor data.

The negative effects may include a poor lightning condition, a weather condition, a cloud condition, an overcast condition, a gloom condition, a fog condition, a wind condition, a storm condition, a rain condition, a dust condition, a breeze condition, a sensor failure condition, a traffic condition, a sensor blockage condition, a sensor calibration condition, or some combination thereof.

The perception task module may include a first algorithm module. The first algorithm module may generate first training task data using the training sensor data. The first algorithm module may generate the first training task data based on a first perception task. The first perception task may include object classification, object detection, scene segmentation, speed calculation, vehicle detection, pedestrian detection, traffic light detection, vehicle position detection, object intention prediction, traffic sign recognition, or any other appropriate perception task.

The perception task module may determine pre-identified errors of the first task data using a loss function, the first training task data, and the ground truth labels. The perception task module may train an EE module using a ML algorithm, the training task data, the pre-identified latent representations, the pre-identified errors, or some combination thereof. The EE module may estimate the error distribution for the first task data.

The perception task module may receive first sensor data representative of an environment of a vehicle. The perception task module may receive the first sensor data from a first sensor. The first sensor may include a camera, an infrared, a radar, a lidar, a sonar, a microphone, or any other appropriate sensor. The first algorithm module may generate first task data using the first sensor data in accordance with the first perception task. The first task data may include a first set of features of the environment.

The perception task module may identify the first perception task as a sensitive perception task. Responsive to the perception task module identifying the first perception task as a sensitive task, the perception task module may identify a first latent representation of a negative effect of the environment within the first sensor data.

The NELR module may determine a perception type of the first perception task. The NELR module may identify a sub negative effect of the environment using the first sensor data based on the perception type. In addition, the NELR module may map the sub negative effect to a pre-identified latent representation according to Equation 1. The NELR module may identify the pre-identified latent representation as the first latent representation corresponding to the first sensor data.

The NELR may identify a first aspect and a second aspect of the first perception task. The NELR module may also identify a sub negative effect of the environment using the first sensor data based on the first perception type. In addition, the NELR may map the sub negative effect to a first pre-identified latent representation that corresponds to the first aspect. The NELR module may also map the sub negative effect to a second pre-identified latent representation that corresponds to the second aspect. The first identified latent representation may include the first pre-identified latent representation and the second pre-identified latent representation.

The EE module may estimate a first error distribution for the first task data. The EE module may estimate the first error distribution based on the first identified latent representation, the first task data, the first perception task, or some combination thereof.

The EE module may map the first identified latent representation to a first pre-identified error. The first pre-identified error may correspond to an algorithm associated with the first perception task based on the perception type. The EE module may map the first identified latent representation to the first pre-identified error and map the first identified latent representation to the first set of features according to Equation 2.

f: [symbol] ^{P+K}→ [symbol] ^{K×K} Equation 2

In Equation 2, P may represent a dimensionality of a vector indicating an intensity of each of pre-identified latent representations and K may represent a dimensionality of the algorithm associated with the first perception task.

The EE module may map the first identified latent representation to a first feature based on the perception type. The first estimated error distribution may be based on the first pre-identified error and the first feature.

The EE module may identify a first aspect and a second aspect of the first perception task. The EE module may map the first identified latent representation to a first pre-identified error corresponding to the first aspect. The EE module may also map the first identified latent representation to a second pre-identified error corresponding to the second aspect. The first pre-identified error and the second pre-identified error may correspond to an algorithm associated with the perception task based on the perception type. The EE module may map the first identified latent representation to a first feature based on the perception type. The first estimated error distribution may be based on the first pre-identified error, the second pre-identified error, and the first feature.

The perception task module may generate first output data that includes a normalized distribution of the first set of features based on the first estimated error distribution and the first task data. The first output data may include a multivariate normal distribution.

The perception task module may receive second sensor data representative of the environment of the vehicle. The perception task module may receive the second sensor data from a second sensor. The second sensor may include a camera, an infrared, a radar, a lidar, a sonar, a microphone, or any other appropriate sensor.

A second algorithm module may generate second task data using the second sensor data in accordance with a second perception task. The second task data may include a second set of features of the environment. The NELR module may identify a second latent representation of a negative effect of the environment within the second sensor data. The EE module may estimate a second error distribution for the second task data based on the identified second latent representation, the second task data, the second perception task, or some combination thereof.

The perception task module may generate second output data. The second output data may include a normalized distribution of the second set of features based on the second estimated error distribution and the second task data.

The perception task module may perform risk analysis using the first output data, the second output data, or some combination thereof. The risk analysis may include a responsibility sensitive safety model.

Example 1 may include a device including a processor configured to: receive sensor data representative of an environment of a vehicle; generate task data using the sensor data in accordance with a perception task, the task data including a plurality of features of the environment; identify a latent representation of a negative effect of the environment within the sensor data; estimate an error distribution for the task data based on the identified latent representation, the task data, and the perception task; and generate output data including a normalized distribution of the plurality of features based on the estimated error distribution and the task data.

Example 2 may include the device of example 1, wherein the perception task includes a first perception task, the sensor data includes first sensor data, the task data includes first task data, the plurality of features include a first plurality of features, the latent representation includes a first latent representation, the output data includes first output data, and the processor is further configured to: receive second sensor data representative of the environment; generate second task data using the second sensor data in accordance with a second perception task, the second task data including a second plurality of features of the environment; identify a second latent representation of a negative effect of the environment within the second sensor data; estimate an error distribution for the second task data based on the identified second latent representation, the second task data, and the second perception task; and generate second output data including a normalized distribution of the second plurality of features based on the estimated error distribution for the second task and the second task data.

Example 3 may include the device of example 1, wherein the processor is further configured to identify the perception task as a sensitive perception task, wherein responsive to the perception task being identified as the sensitive perception task, the processor is configured to identify the latent representation of the negative effect of the environment within the sensor data.

Example 4 may include the device of example 1, wherein the processor is configured to identify the latent representation of the negative effect of the environment within the sensor data by: determining a perception type of the perception task; identifying a sub negative effect of the environment using the sensor data based on the perception type; and mapping the sub negative effect to a pre-identified latent representation of a plurality of pre-identified latent representations, wherein the identified latent representation includes the pre-identified latent representation.

Example 5 may include the device of example 4, wherein the processor is configured to map the sub negative effect to the pre-identified latent representation according to:

f: [symbol] ^{M}→ [symbol] ^{P}

in which M represents a dimensionality of the sensor data and P represents a dimensionality of a vector indicating an intensity of each pre-identified latent representation of the plurality of pre-identified latent representations.

Example 6 may include the device of example 1, wherein the processor is configured to identify the latent representation of the negative effect of the environment within the sensor data by: determining a perception type of the perception task; identifying a first aspect and a second aspect of the perception task; identifying a sub negative effect of the environment using the sensor data based on the perception type; mapping the sub negative effect to a first pre-identified latent representation of a plurality of pre-identified latent representations, wherein the first pre-identified latent representation corresponds to the first aspect; and mapping the sub negative effect to a second pre-identified latent representation of the plurality of pre-identified latent representations, wherein the second pre-identified latent representation corresponds to the second aspect, wherein the identified latent representation includes the first pre-identified latent representation and the second pre-identified latent representation.

Example 7 may include the device of example 1, wherein the processor is further configured to: receive a DSD including a plurality of pre-identified latent representations and a plurality of ground truth labels corresponding to the plurality of pre-identified latent representations; and train a NELR module using a machine learning algorithm, the plurality of pre-identified latent representations, and the plurality of ground truth labels, wherein the processor is configured to identify the latent representation of the negative effect within the sensor data using the NELR module.

Example 8 may include the device of example 1, wherein the processor is configured to estimate the error distribution for the task data based on the identified latent representation, the task data, and the perception task by: determining a perception type of the perception task; mapping the identified latent representation to a pre-identified error, wherein the pre-identified error corresponds to an algorithm associated with the perception task based on the perception type; and mapping the identified latent representation to a feature of the plurality of features based on the perception type, wherein the estimated error distribution is based on the pre-identified error and the feature that the identified latent representation is mapped to.

Example 9 may include the device of example 8, wherein the processor is configured to map the identified latent representation to the pre-identified error and map the identified latent representation to the feature according to:

f: [symbol] ^{P+K}→ [symbol] ^{K×K}

in which P represents a dimensionality of a vector indicating an intensity of each pre-identified latent representation of the plurality of pre-identified latent representations and K represents a dimensionality of the algorithm associated with the perception task.

Example 10 may include the device of example 1, wherein the processor is configured to estimate the error distribution for the task data based on the identified latent representation, the task data, and the perception task by: determining a perception type of the perception task; identifying a first aspect and a second aspect of the perception task; mapping the identified latent representation to a first pre-identified error corresponding to the first aspect, wherein the first pre-identified error corresponds to an algorithm associated with the perception task based on the perception type; mapping the identified latent representation to a second pre-identified error corresponding to the second aspect, wherein the second pre-identified error corresponds to an algorithm associated with the perception task based on the perception type; and mapping the identified latent representation to a feature of the plurality of features based on the perception type, wherein the estimated error distribution is based on the first pre-identified error, the second pre-identified error, and the feature that the identified latent representation is mapped to.

Example 11 may include the device of example 1, wherein the processor is further configured to: receive a DSD including a plurality of pre-identified latent representations, a plurality of ground truth labels corresponding to the plurality of pre-identified latent representations, and training sensor data; generate training task data using the training sensor data in accordance with the perception task; determine a plurality of pre-identified errors of an algorithm corresponding to the perception task using a loss function, the training task data, and the plurality of ground truth labels; and train an EE module using a machine learning algorithm, the training task data, the plurality of pre-identified latent representations, and the plurality of pre-identified errors, wherein the processor is configured to estimate the error distribution for the task data using the EE module.

Example 12 may include the device of example 11, wherein the DSD includes a domain specific distribution of sensor defects and environmental conditions

Example 13 may include the device of example 1, wherein the output data includes a multivariate normal distribution.

Example 14 may include the device of example 1, wherein the processor is further configured to perform a risk analysis using the output data, wherein the risk analysis includes responsibility sensitive safety model.

Example 15 may include the device of example 1, wherein the processor is configured to receive the sensor data from a sensor including at least one of a camera, an infrared, a radar, a lidar, a sonar, and a microphone.

Example 16 may include the device of example 1, wherein the perception task includes at least one of object classification, object detection, scene segmentation, speed calculation, vehicle detection, pedestrian detection, traffic light detection, vehicle position detection, object intention prediction, and traffic sign recognition.

Example 17 may include the device of example 1, wherein the negative effect includes at least one of a poor lightning condition, a weather condition, a cloud condition, an overcast condition, a gloom condition, a fog condition, a wind condition, a storm condition, a rain condition, a dust condition, a breeze condition, a sensor failure condition, a traffic condition, a sensor blockage condition, and a sensor calibration condition.

Example 18 may include the device of example 1, wherein the device includes an AV navigation system.

Example 19 may include a non-transitory computer-readable medium including: a memory having computer-readable instructions stored thereon; and a processor operatively coupled to the memory and configured to read and execute the computer-readable instructions to perform or control performance of operations including: receiving sensor data representative of an environment of a vehicle; generating task data using the sensor data in accordance with a perception task, the task data including a plurality of features of the environment; identifying a latent representation of a negative effect of the environment within the sensor data; estimating an error distribution for the task data based on the identified latent representation, the task data, and the perception task; and generating output data including a normalized distribution of the plurality of features based on the estimated error distribution and the task data.

Example 20 may include the non-transitory computer-readable medium of example 19, wherein the perception task includes a first perception task, the sensor data includes first sensor data, the task data includes first task data, the plurality of features include a first plurality of features, the latent representation includes a first latent representation, and the output data includes first output data, the operations further including: receiving second sensor data representative of the environment; generating second task data using the second sensor data in accordance with a second perception task, the second task data including a second plurality of features of the environment; identifying a second latent representation of a negative effect of the environment within the second sensor data; estimating an error distribution for the second task data based on the identified second latent representation, the second task data, and the second perception task; and generating second output data including a normalized distribution of the second plurality of features based on the estimated error distribution for the second task and the second task data.

Example 21 may include the non-transitory computer-readable medium of example 19, wherein the operation identify the latent representation of the negative effect of the environment within the sensor data includes: determining a perception type of the perception task; identifying a sub negative effect of the environment using the sensor data based on the perception type; and mapping the sub negative effect to a pre-identified latent representation of a plurality of pre-identified latent representations, wherein the identified latent representation includes the pre-identified latent representation.

Example 22 may include the non-transitory computer-readable medium of example 19, wherein the operation identify the latent representation of the negative effect of the environment within the sensor data includes: determining a perception type of the perception task; identifying a first aspect and a second aspect of the perception task; identifying a sub negative effect of the environment using the sensor data based on the perception type; mapping the sub negative effect to a first pre-identified latent representation of a plurality of pre-identified latent representations, wherein the first pre-identified latent representation corresponds to the first aspect; and mapping the sub negative effect to a second pre-identified latent representation of the plurality of pre-identified latent representations, wherein the second pre-identified latent representation corresponds to the second aspect, wherein the identified latent representation includes the first pre-identified latent representation and the second pre-identified latent representation.

Example 23 may include the non-transitory computer-readable medium of example 19, the operations further including: receiving a DSD including a plurality of pre-identified latent representations and a plurality of ground truth labels corresponding to the plurality of pre-identified latent representations; and training a NELR module using a machine learning algorithm, the plurality of pre-identified latent representations, and the plurality of ground truth labels, wherein the processor is configured to identify the latent representation of the negative effect within the sensor data using the NELR module.

Example 24 may include the non-transitory computer-readable medium of example 19, wherein the operation estimate the error distribution for the task data based on the identified latent representation, the task data, and the perception task includes: determining a perception type of the perception task; mapping the identified latent representation to a pre-identified error, wherein the pre-identified error corresponds to an algorithm associated with the perception task based on the perception type; and mapping the identified latent representation to a feature of the plurality of features based on the perception type, wherein the estimated error distribution is based on the pre-identified error and the feature that the identified latent representation is mapped to.

Example 25 may include the non-transitory computer-readable medium of example 19, wherein the operation estimate the error distribution for the task data based on the identified latent representation, the task data, and the perception task includes: determining a perception type of the perception task; identifying a first aspect and a second aspect of the perception task; mapping the identified latent representation to a first pre-identified error corresponding to the first aspect, wherein the first pre-identified error corresponds to an algorithm associated with the perception task based on the perception type; mapping the identified latent representation to a second pre-identified error corresponding to the second aspect, wherein the second pre-identified error corresponds to an algorithm associated with the perception task based on the perception type; and mapping the identified latent representation to a feature of the plurality of features based on the perception type, wherein the estimated error distribution is based on the first pre-identified error, the second pre-identified error, and the feature that the identified latent representation is mapped to.

Example 26 may include the non-transitory computer-readable medium of example 19, the operations further including: receiving a DSD including a plurality of pre-identified latent representations, a plurality of ground truth labels corresponding to the plurality of pre-identified latent representations, and training sensor data; generating training task data using the training sensor data in accordance with the perception task; determining a plurality of pre-identified errors of an algorithm corresponding to the perception task using a loss function, the training task data, and the plurality of ground truth labels; and training an EE module using a machine learning algorithm, the training task data, the plurality of pre-identified latent representations, and the plurality of pre-identified errors, wherein the processor is configured to estimate the error distribution for the task data using the EE module.

Example 27 may include a system, including: means to receive sensor data representative of an environment of a vehicle; means to generate task data using the sensor data in accordance with a perception task, the task data including a plurality of features of the environment; means to identify a latent representation of a negative effect of the environment within the sensor data; means to estimate an error distribution for the task data based on the identified latent representation, the task data, and the perception task; and means to generate output data including a normalized distribution of the plurality of features based on the estimated error distribution and the task data.

Example 28 may include the system of example 27, wherein the perception task includes a first perception task, the sensor data includes first sensor data, the task data includes first task data, the plurality of features include a first plurality of features, the latent representation includes a first latent representation, and the output data includes first output data, the system further including: means to receive second sensor data representative of the environment; means to generate second task data using the second sensor data in accordance with a second perception task, the second task data including a second plurality of features of the environment; means to identify a second latent representation of a negative effect of the environment within the second sensor data; means to estimate an error distribution for the second task data based on the identified second latent representation, the second task data, and the second perception task; and means to generate second output data including a normalized distribution of the second plurality of features based on the estimated error distribution for the second task and the second task data.

Example 29 may include the system of example 27, wherein the means to identify the latent representation of the negative effect of the environment within the sensor data include: means to determine a perception type of the perception task; means to identify a sub negative effect of the environment using the sensor data based on the perception type; and means to map the sub negative effect to a pre-identified latent representation of a plurality of pre-identified latent representations, wherein the identified latent representation includes the pre-identified latent representation.

Example 30 may include the system of example 27, wherein the means to identify the latent representation of the negative effect of the environment within the sensor data includes: means to determine a perception type of the perception task; means to identify a first aspect and a second aspect of the perception task; means to identify a sub negative effect of the environment using the sensor data based on the perception type; means to map the sub negative effect to a first pre-identified latent representation of a plurality of pre-identified latent representations, wherein the first pre-identified latent representation corresponds to the first aspect; and means to map the sub negative effect to a second pre-identified latent representation of the plurality of pre-identified latent representations, wherein the second pre-identified latent representation corresponds to the second aspect, wherein the identified latent representation includes the first pre-identified latent representation and the second pre-identified latent representation.

Example 31 may include the system of example 27 further including: means to receive a DSD including a plurality of pre-identified latent representations and a plurality of ground truth labels corresponding to the plurality of pre-identified latent representations; and means to train a NELR module using a machine learning algorithm, the plurality of pre-identified latent representations, and the plurality of ground truth labels, wherein the processor is configured to identify the latent representation of the negative effect within the sensor data using the NELR module.

Example 32 may include the system of example 27, wherein the means to estimate the error distribution for the task data based on the identified latent representation, the task data, and the perception task includes: means to determine a perception type of the perception task; means to map the identified latent representation to a pre-identified error, wherein the pre-identified error corresponds to an algorithm associated with the perception task based on the perception type; and means to map the identified latent representation to a feature of the plurality of features based on the perception type, wherein the estimated error distribution is based on the pre-identified error and the feature that the identified latent representation is mapped to.

Example 33 may include the system of example 27, wherein the means to estimate the error distribution for the task data based on the identified latent representation, the task data, and the perception task includes: means to determine a perception type of the perception task; means to identify a first aspect and a second aspect of the perception task; means to map the identified latent representation to a first pre-identified error corresponding to the first aspect, wherein the first pre-identified error corresponds to an algorithm associated with the perception task based on the perception type; means to map the identified latent representation to a second pre-identified error corresponding to the second aspect, wherein the second pre-identified error corresponds to an algorithm associated with the perception task based on the perception type; and means to map the identified latent representation to a feature of the plurality of features based on the perception type, wherein the estimated error distribution is based on the first pre-identified error, the second pre-identified error, and the feature that the identified latent representation is mapped to.

Example 34 may include the system of example 27 further including: means to receive a DSD including a plurality of pre-identified latent representations, a plurality of ground truth labels corresponding to the plurality of pre-identified latent representations, and training sensor data; means to generate training task data using the training sensor data in accordance with the perception task; means to determine a plurality of pre-identified errors of an algorithm corresponding to the perception task using a loss function, the training task data, and the plurality of ground truth labels; and means to train an EE module using a machine learning algorithm, the training task data, the plurality of pre-identified latent representations, and the plurality of pre-identified errors, wherein the processor is configured to estimate the error distribution for the task data using the EE module.

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, CPU, GPU, Digital Signal Processor (DSP), FPGA, integrated circuit, ASIC, etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, as described above, which is configured to traverse the ground, e.g., on a street, on a road, on a track, on one or more rails, off-road, etc.

The term “autonomous vehicle” may describe a vehicle capable of implementing at least one navigational change without driver input. A navigational change may describe or include a change in one or more of steering, braking, or acceleration/deceleration of the vehicle. A vehicle may be described as autonomous even in case the vehicle is not fully automatic (for example, fully operational with driver or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances (but not under all circumstances), but may leave other aspects of vehicle navigation to the driver (e.g., braking or braking under certain circumstances). Autonomous vehicles may also include vehicles that share the control of one or more aspects of vehicle navigation under certain circumstances (e.g., hands-on, such as responsive to a driver input) and vehicles that control one or more aspects of vehicle navigation under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

In the context of the present disclosure, “vehicle operation data” may be understood to describe any type of feature related to the operation of a vehicle. By way of example, “vehicle operation data” may describe the status of the vehicle such as the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, etc. More generally, “vehicle operation data” may describe or include varying features or varying vehicle operation data (illustratively, time varying features or data).

Various embodiments herein may utilize one or more machine learning models to perform or control functions of the vehicle (or other functions described herein). The term “model” may, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

Throughout the present disclosure, the following terms will be used as synonyms: driving parameter set, driving model parameter set, safety layer parameter set, driver assistance, automated driving model parameter set, and/or the like (e.g., driving safety parameter set).

Furthermore, throughout the present disclosure, the following terms will be used as synonyms: driving parameter, driving model parameter, safety layer parameter, driver assistance and/or automated driving model parameter, and/or the like (e.g., driving safety parameter).

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to aspects containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although aspects of the present disclosure have been described in detail, various changes, substitutions, and alterations could be made hereto without departing from the spirit and scope of the present disclosure.

What is claimed is:

1. A device comprising a processor configured to:
receive sensor data representative of an environment of a vehicle;
generate task data using the sensor data in accordance with a perception task, the task data comprising a plurality of features of the environment;
identify a latent representation of a negative effect of the environment within the sensor data;
estimate an error distribution for the task data based on the identified latent representation, the task data, and the perception task; and
generate output data comprising a normalized distribution of the plurality of features based on the estimated error distribution and the task data.

2. The device of claim 1, wherein the perception task comprises a first perception task, the sensor data comprises first sensor data, the task data comprises first task data, the plurality of features comprise a first plurality of features, the latent representation comprises a first latent representation, the output data comprises first output data, and the processor is further configured to:
receive second sensor data representative of the environment;
generate second task data using the second sensor data in accordance with a second perception task, the second task data comprising a second plurality of features of the environment;
identify a second latent representation of a negative effect of the environment within the second sensor data;
estimate an error distribution for the second task data based on the identified second latent representation, the second task data, and the second perception task; and
generate second output data comprising a normalized distribution of the second plurality of features based on the estimated error distribution for the second task and the second task data.

3. The device of claim 1, wherein the processor is configured to identify the latent representation of the negative effect of the environment within the sensor data by:
determining a perception type of the perception task;
identifying a sub negative effect of the environment using the sensor data based on the perception type; and
mapping the sub negative effect to a pre-identified latent representation of a plurality of pre-identified latent representations, wherein the identified latent representation comprises the pre-identified latent representation.

4. The device of claim 1, wherein the processor is configured to identify the latent representation of the negative effect of the environment within the sensor data by:
determining a perception type of the perception task;
identifying a first aspect and a second aspect of the perception task;
identifying a sub negative effect of the environment using the sensor data based on the perception type;
mapping the sub negative effect to a first pre-identified latent representation of a plurality of pre-identified latent representations, wherein the first pre-identified latent representation corresponds to the first aspect; and
mapping the sub negative effect to a second pre-identified latent representation of the plurality of pre-identified latent representations, wherein the second pre-identified latent representation corresponds to the second aspect, wherein the identified latent representation comprises the first pre-identified latent representation and the second pre-identified latent representation.

5. The device of claim 1, wherein the processor is further configured to:
receive a domain specific dataset (DSD) comprising a plurality of pre-identified latent representations and a plurality of ground truth labels corresponding to the plurality of pre-identified latent representations; and
train a negative effect latent representation (NELR) module using a machine learning algorithm, the plurality of pre-identified latent representations, and the plurality of ground truth labels, wherein the processor is configured to identify the latent representation of the negative effect within the sensor data using the NELR module.

6. The device of claim 1, wherein the processor is configured to estimate the error distribution for the task data based on the identified latent representation, the task data, and the perception task by:
determining a perception type of the perception task;
mapping the identified latent representation to a pre-identified error, wherein the pre-identified error corresponds to an algorithm associated with the perception task based on the perception type; and
mapping the identified latent representation to a feature of the plurality of features based on the perception type, wherein the estimated error distribution is based on the pre-identified error and the feature that the identified latent representation is mapped to.

7. The device of claim 1, wherein the processor is further configured to:
receive a domain specific dataset (DSD) comprising a plurality of pre-identified latent representations, a plurality of ground truth labels corresponding to the plurality of pre-identified latent representations, and training sensor data;
generate training task data using the training sensor data in accordance with the perception task;
determine a plurality of pre-identified errors of an algorithm corresponding to the perception task using a loss function, the training task data, and the plurality of ground truth labels; and
train an error estimation (EE) module using a machine learning algorithm, the training task data, the plurality of pre-identified latent representations, and the plurality of pre-identified errors, wherein the processor is configured to estimate the error distribution for the task data using the EE module.

8. A non-transitory computer-readable medium comprising:
a memory having computer-readable instructions stored thereon; and
a processor operatively coupled to the memory and configured to read and execute the computer-readable instructions to perform or control performance of operations comprising:
receiving sensor data representative of an environment of a vehicle;
generating task data using the sensor data in accordance with a perception task, the task data comprising a plurality of features of the environment;
identifying a latent representation of a negative effect of the environment within the sensor data;
estimating an error distribution for the task data based on the identified latent representation, the task data, and the perception task; and
generating output data comprising a normalized distribution of the plurality of features based on the estimated error distribution and the task data.

9. The non-transitory computer-readable medium of claim 8, wherein the perception task comprises a first perception task, the sensor data comprises first sensor data, the task data comprises first task data, the plurality of features comprise a first plurality of features, the latent representation comprises a first latent representation, and the output data comprises first output data, the operations further comprising:
receiving second sensor data representative of the environment;
generating second task data using the second sensor data in accordance with a second perception task, the second task data comprising a second plurality of features of the environment;
identifying a second latent representation of a negative effect of the environment within the second sensor data;
estimating an error distribution for the second task data based on the identified second latent representation, the second task data, and the second perception task; and
generating second output data comprising a normalized distribution of the second plurality of features based on the estimated error distribution for the second task and the second task data.

10. The non-transitory computer-readable medium of claim 8, the operations further comprising:
receiving a domain specific dataset (DSD) comprising a plurality of pre-identified latent representations and a plurality of ground truth labels corresponding to the plurality of pre-identified latent representations; and
training a negative effect latent representation (NELR) module using a machine learning algorithm, the plurality of pre-identified latent representations, and the plurality of ground truth labels, wherein the processor is configured to identify the latent representation of the negative effect within the sensor data using the NELR module.

11. The non-transitory computer-readable medium of claim 8, wherein the operation estimate the error distribution for the task data based on the identified latent representation, the task data, and the perception task comprises:
determining a perception type of the perception task;
mapping the identified latent representation to a pre-identified error, wherein the pre-identified error corresponds to an algorithm associated with the perception task based on the perception type; and
mapping the identified latent representation to a feature of the plurality of features based on the perception type, wherein the estimated error distribution is based on the pre-identified error and the feature that the identified latent representation is mapped to.

12. The non-transitory computer-readable medium of claim 8, wherein the operation estimate the error distribution for the task data based on the identified latent representation, the task data, and the perception task comprises:
determining a perception type of the perception task;
identifying a first aspect and a second aspect of the perception task;
mapping the identified latent representation to a first pre-identified error corresponding to the first aspect, wherein the first pre-identified error corresponds to an algorithm associated with the perception task based on the perception type;
mapping the identified latent representation to a second pre-identified error corresponding to the second aspect, wherein the second pre-identified error corresponds to an algorithm associated with the perception task based on the perception type; and
mapping the identified latent representation to a feature of the plurality of features based on the perception type, wherein the estimated error distribution is based on the first pre-identified error, the second pre-identified error, and the feature that the identified latent representation is mapped to.

13. The non-transitory computer-readable medium of claim 8, the operations further comprising:
receiving a domain specific dataset (DSD) comprising a plurality of pre-identified latent representations, a plurality of ground truth labels corresponding to the plurality of pre-identified latent representations, and training sensor data;
generating training task data using the training sensor data in accordance with the perception task;
determining a plurality of pre-identified errors of an algorithm corresponding to the perception task using a loss function, the training task data, and the plurality of ground truth labels; and
training an error estimation (EE) module using a machine learning algorithm, the training task data, the plurality of pre-identified latent representations, and the plurality of pre-identified errors, wherein the processor is configured to estimate the error distribution for the task data using the EE module.

14. A system, comprising:
means to receive sensor data representative of an environment of a vehicle;
means to generate task data using the sensor data in accordance with a perception task, the task data comprising a plurality of features of the environment;
means to identify a latent representation of a negative effect of the environment within the sensor data;
means to estimate an error distribution for the task data based on the identified latent representation, the task data, and the perception task; and
means to generate output data comprising a normalized distribution of the plurality of features based on the estimated error distribution and the task data.

15. The system of claim 14, wherein the perception task comprises a first perception task, the sensor data comprises first sensor data, the task data comprises first task data, the plurality of features comprise a first plurality of features, the latent representation comprises a first latent representation, and the output data comprises first output data, the system further comprising:
means to receive second sensor data representative of the environment;
means to generate second task data using the second sensor data in accordance with a second perception task, the second task data comprising a second plurality of features of the environment;
means to identify a second latent representation of a negative effect of the environment within the second sensor data;
means to estimate an error distribution for the second task data based on the identified second latent representation, the second task data, and the second perception task; and
means to generate second output data comprising a normalized distribution of the second plurality of features based on the estimated error distribution for the second task and the second task data.

16. The system of claim 14, wherein the means to identify the latent representation of the negative effect of the environment within the sensor data comprise:
means to determine a perception type of the perception task;
means to identify a sub negative effect of the environment using the sensor data based on the perception type; and
means to map the sub negative effect to a pre-identified latent representation of a plurality of pre-identified latent representations, wherein the identified latent representation comprises the pre-identified latent representation.

17. The system of claim 14, wherein the means to identify the latent representation of the negative effect of the environment within the sensor data comprises:
means to determine a perception type of the perception task;
means to identify a first aspect and a second aspect of the perception task;
means to identify a sub negative effect of the environment using the sensor data based on the perception type;
means to map the sub negative effect to a first pre-identified latent representation of a plurality of pre-identified latent representations, wherein the first pre-identified latent representation corresponds to the first aspect; and
means to map the sub negative effect to a second pre-identified latent representation of the plurality of pre-identified latent representations, wherein the second pre-identified latent representation corresponds to the second aspect, wherein the identified latent representation comprises the first pre-identified latent representation and the second pre-identified latent representation.

18. The system of claim 14 further comprising:
means to receive a domain specific dataset (DSD) comprising a plurality of pre-identified latent representations and a plurality of ground truth labels corresponding to the plurality of pre-identified latent representations; and
means to train a negative effect latent representation (NELR) module using a machine learning algorithm, the plurality of pre-identified latent representations, and the plurality of ground truth labels, wherein the processor is configured to identify the latent representation of the negative effect within the sensor data using the NELR module.

19. The system of claim 14, wherein the means to estimate the error distribution for the task data based on the identified latent representation, the task data, and the perception task comprises:
means to determine a perception type of the perception task;
means to map the identified latent representation to a pre-identified error, wherein the pre-identified error corresponds to an algorithm associated with the perception task based on the perception type; and
means to map the identified latent representation to a feature of the plurality of features based on the perception type, wherein the estimated error distribution is based on the pre-identified error and the feature that the identified latent representation is mapped to.

20. The system of claim 14 further comprising:
means to receive a domain specific dataset (DSD) comprising a plurality of pre-identified latent representations, a plurality of ground truth labels corresponding to the plurality of pre-identified latent representations, and training sensor data;
means to generate training task data using the training sensor data in accordance with the perception task;
means to determine a plurality of pre-identified errors of an algorithm corresponding to the perception task using a loss function, the training task data, and the plurality of ground truth labels; and
means to train an error estimation (EE) module using a machine learning algorithm, the training task data, the plurality of pre-identified latent representations, and the plurality of pre-identified errors, wherein the processor is configured to estimate the error distribution for the task data using the EE module.
